(19) United States
(12) Patent Application Publication
(10) Pub. No.: US 2025/0013093 A1
(43) Pub. Date: Jan. 9, 2025

(54) DISPLAY MODULE, MANUFACTURING METHOD, AND DISPLAY DEVICE

(71) Applicants: CHENGDU BOE OPTOELECTRONICS TECHNOLOGY CO., LTD., Chengdu, Sichuan (CN); BOE TECHNOLOGY GROUP CO., LTD., Beijing (CN)

(72) Inventors: Haohao Li, Beijing (CN); Yin Deng, Beijing (CN); Bo Wu, Beijing (CN); Changyi Wang, Beijing (CN)

(73) Assignees: CHENGDU BOE OPTOELECTRONICS TECHNOLOGY CO., LTD., Chengdu, Sichuan (CN); BOE TECHNOLOGY GROUP CO., LTD., Beijing (CN)

(21) Appl. No.: 18/274,249

(22) PCT Filed: Jul. 29, 2022
(86) PCT No.: PCT/CN2022/109189

§ 371 Date: Jul. 26, 2023

(51) Int. Cl. G02F 1/1333

(52) U.S. Cl. CPC G02F 1/133382; G02F 1/133317; G02F 1/133331; G02F 1/133388

(57) ABSTRACT

The present disclosure provides a display module, a manufacturing method thereof, and a display device. The display module incudes: a liquid crystal cell including a first substrate, a second substrate, a liquid crystal layer arranged between the first substrate and the second substrate, and a heating source arranged in the liquid crystal cell and configured to heat the liquid crystal layer; and a low thermal conductivity medium layer, at least a part of the low thermal conductivity medium layer being arranged on a side of the liquid crystal layer close to the display side, thermal conductivity of the low thermal conductivity medium layer being smaller than a predetermined value, the low thermal conductivity medium layer being configured to at least reduce heat transferred from an interior of the liquid crystal cell to the outside via the display side, so as to accumulate the heat in the liquid crystal layer.

### TECHNICAL FIELD

The present disclosure relates to the field of display technology, in particular to a display module, a manufacturing method thereof, and a display device.

### BACKGROUND

In some special working environments, a liquid crystal display device needs to be used in a large range of environmental temperatures. However, a viscosity coefficient of a liquid crystal material increases at a low temperature, so a threshold voltage increases, a slow response occurs, and even liquid crystals crystallize. At this time, the liquid crystal display device cannot operate normally. A response time of the liquid crystals is obviously affected by the temperature, so in a low-temperature environment, an obvious afterimage occurs. Hence, in the special working environments, there is an urgent need to increase a low-temperature range of the liquid crystal display device, so as to enable the liquid crystal display device to operate normally in the low-temperature environment.

### SUMMARY

An object of the present disclosure is to provide a display module, a manufacturing method thereof and a display device, so as to increase a heating speed and a heating temperature of a liquid crystal layer, increase a response time of liquid crystals and prevent the occurrence of afterimages, thereby to improve the display quality and reduce the power consumption.

The technical solutions in the embodiments of the present disclosure will be described as follows.

In one aspect, the present disclosure provides in some embodiments a display module, including: a liquid crystal cell including a first substrate and a second substrate arranged opposite to each other, a liquid crystal layer arranged between the first substrate and the second substrate, and a heating source arranged in the liquid crystal cell and configured to heat the liquid crystal layer, a side of the first substrate away from the second substrate being a display side, and a side of the second substrate away from the first substrate being a non-display side; and a low thermal conductivity medium layer, at least a part of the low thermal conductivity medium layer being arranged on a side of the liquid crystal layer close to the display side, thermal conductivity of the low thermal conductivity medium layer being smaller than a predetermined value, the low thermal conductivity medium layer being configured to at least reduce heat transferred from an interior of the liquid crystal cell to the outside via the display side, so as to accumulate the heat in the liquid crystal layer.

In a possible embodiment of the present disclosure, the predetermined value is thermal conductivity of all film layers on a side of the liquid crystal layer close to the non-display side.

In a possible embodiment of the present disclosure, at least a part of the low thermal conductivity medium layer is arranged inside the liquid crystal cell, and/or at least a part of the low thermal conductivity medium layer is arranged outside the liquid crystal cell.

In a possible embodiment of the present disclosure, when the low thermal conductivity medium layer is arranged outside the liquid crystal cell, at least a part of the low thermal conductivity medium layer is arranged on the display side; and when the low thermal conductivity medium layer is arranged inside the liquid crystal cell, at least a part of the low thermal conductivity medium layer is arranged between a base substrate of the first substrate and the liquid crystal layer.

In a possible embodiment of the present disclosure, the low thermal conductivity medium layer includes an interlayer formation member for forming an interlayer, and the interlayer is filled with a low thermal conductivity medium.

In a possible embodiment of the present disclosure, the low thermal conductivity medium includes an air medium.

In a possible embodiment of the present disclosure, the display module includes a display region and a non-display region surrounding the display region, at least a part of the interlayer formation member includes a transparent enclosure, an internal cavity of the transparent enclosure forms the interlayer, and an orthogonal projection of the interlayer onto the first substrate at least covers the display region.

In a possible embodiment of the present disclosure, the transparent enclosure is made of one or more of polyethylene terephthalate and polyimide.

In a possible embodiment of the present disclosure, the display module includes a display region and a non-display region arranged at a periphery of the display region. At least a part of the interlayer formation member includes: two transparent clamping plates arranged opposite to each other to form a cell; and a support layer fixed between the two transparent clamping plates in the non-display region to form the interlayer with the two transparent clamping plates.

In a possible embodiment of the present disclosure, one of the two transparent clamping plates is the base substrate of the first substrate, and the other is a transparent cover plate arranged on the base substrate of the first substrate.

In a possible embodiment of the present disclosure, the base substrate and the transparent cover plate are made of at least one of glass, acrylics or polyoxymethylene.

In a possible embodiment of the present disclosure, the display module includes a display region and a non-display region arranged at a periphery of the display region. The heating source includes: a heating source terminal arranged in the non-display region, the heating source terminal including a first heating source terminal for outputting a high voltage and a second heating source terminal for outputting a low voltage; and at least one heating electrode arranged between a base substrate of the first substrate and a base substrate of the second substrate, both ends of each heating electrode being coupled to the first heating source terminal and the second heating source terminal respectively.

In another aspect, the present disclosure provides in some embodiments a display device including the above-mentioned display module.

In yet another aspect, the present disclosure provides in some embodiments a method for manufacturing the above-mentioned display module, including forming a first substrate and a second substrate in such a manner as to be arranged opposite to each other, and forming a liquid crystal layer between the first substrate and the second substrate to form a liquid crystal cell. The liquid crystal cell is provided with a heating source for beating the liquid crystal layer, the heating source is arranged on at least one of the first substrate and the second substrate, a low thermal conductivity medium layer is formed at least on a display side of the first substrate or a side of the first substrate close to the liquid crystal layer, thermal conductivity of the low thermal conductivity medium layer is smaller than a predetermined value, and the low thermal conductivity medium layer is configured to at least reduce heat transferred from an interior of the liquid crystal cell to the outside via the display side, so as to accumulate the heat in the liquid crystal layer.

In a possible embodiment of the present disclosure, the forming the low thermal conductivity medium layer at least on the display side of the first substrate or a side of the first substrate close to the liquid crystal layer specifically includes: forming two layers of thin films through extrusion molding or injection molding, and applying a sealant so as to form a transparent enclosure with an interlayer, a thickness of the interlayer being determined in accordance with a thickness of the sealant; and attaching the transparent enclosure to a side of the first substrate close to the display side or a side of the first substrate close to the liquid crystal layer, or the forming the low thermal conductivity medium layer on at least the display side of the first substrate or a side of the first substrate close to the liquid crystal layer specifically includes enabling a transparent cover plate to be arranged opposite to a base substrate of the first substrate through a support layer at a periphery of the transparent cover plate, and the transparent substrate is arranged on the display side of the first substrate or on a side of the first substrate close to the liquid crystal layer.

The present disclosure has the following beneficial effects.

According to the display module, the manufacturing method thereof, and the display device in the embodiments of the present disclosure, the beating source for heating the liquid crystal layer is arranged in the liquid crystal cell, the low thermal conductivity medium layer is at least arranged on a side of the liquid crystal layer close to the display side, and the low thermal conductivity medium layer has relatively low heat conductivity. As a result, it is able to increase a thermal resistance from the heating source to the display side, at least reduce the heat transferred from the interior of the liquid crystal cell to the outside via the display side, i.e., reduce a heat loss, and increase the accumulation of heat in the liquid crystal layer, thereby to rapidly start the display module at a low temperature and ensure a response speed of liquid crystals. In addition, as compared with a scheme without any low thermal conductivity medium layer, it is able to reduce the power consumption at a same response speed.

### BRIEF DESCRIPTION OF THE DRAWINGS

FIG. 1 is a schematic view showing a display module in the related art;

FIG. 2 is a schematic view showing a heat conduction model (in series) for the display module in FIG. 1;

FIG. 3 is a schematic view showing a display module according to one embodiment of the present disclosure;

FIG. 4 is a schematic view showing a heat conduction model (in series) of the display module in FIG. 3;

FIG. 5 is another schematic view showing the display module according to one embodiment of the present disclosure; and

FIG. 6 is a curve diagram showing changes in a temperature at a light-exiting side of the conventional display module and a temperature at a light-exiting side of the display module according to the embodiments of the present disclosure along with time.

### DETAILED DESCRIPTION

In order to make the objects, the technical solutions and the advantages of the present disclosure more apparent, the present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “include” or “including” intends to indicate that an element or object before the word contains an element or object or equivalents thereof listed after the word, without excluding any other element or object. Such words as “connect/connected to” or “couple/coupled to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

The following description will be given at first.

In the related art, in some special working environments, a liquid crystal display device needs to be used in a large range of environmental temperatures. However, a viscosity coefficient of a liquid crystal material increases at a low temperature, so a threshold voltage increases, a slow response occurs, and even liquid crystals crystallize. At this time, the liquid crystal display device cannot operate normally. A response time of the liquid crystals is obviously affected by the temperature, so in a low-temperature environment, an obvious afterimage occurs.

It is found through researches that, when a heating source is arrange din a liquid crystal display module to heat liquid crystal molecules in the low-temperature environment, it is able to reduce a response time of the liquid crystals to some extent, but it is still impossible to improve the display quality within a short time period. In addition, due to the additional heating source, the power consumption of the liquid crystal display device increases remarkably. Hence, there is an urgent need to increase the response speed and reduce the power consumption.

It is found that, the above-mentioned problem is caused due to a heat transfer rate. Due to the limit of a heat transfer mechanism, it takes time for the heat from the heating source to be transferred to, and heat, a liquid crystal layer, and the time is related to a heat conduction coefficient and a thickness of a film layer. The heat is transferred to the liquid crystal layer but cannot be accumulated in the liquid crystal layer. Instead, the heat is transferred to a surface of a screen, and finally to the outside through the heat convection with air. In this process, it is impossible to heat the liquid crystals through the heat accumulation. At this time, the heat needs to be accumulated rapidly through increasing a voltage or current. However, the power consumption of the heating source is increased remarkably, and thereby the response speed and the power consumption of the display device increase.

Detailed description will be given as follows.

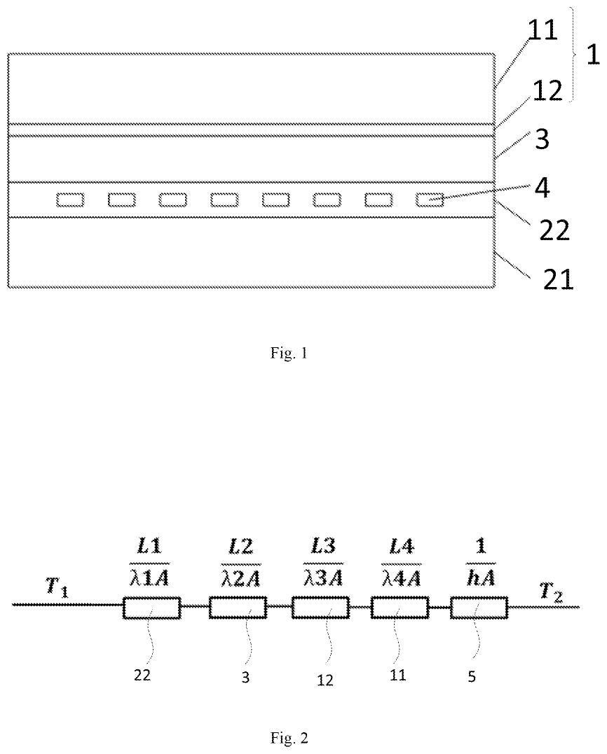

As shown in FIG. 1, for a conventional display module, a heating source is arranged inside a liquid crystal cell. The display module includes a color film substrate 1 and an array substrate 2 arranged opposite to each other to form a cell, a liquid crystal layer 3 arranged between the color film substrate 1 and the array substrate 2, and the heating source 4 arranged in the liquid crystal cell. The array substrate 2 includes a Thin Film Transistor (TFT) substrate 21 and a display driving layer 22, and the color film substrate 1 includes a Color Filter (CF) substrate 11, a color filter layer, a black matrix layer 12, etc.

FIG. 2 shows a heat conduction model (in series) of the display module. Heat generated by the heating source is transferred through the display driving layer 22, the liquid crystal layer 3, the color filter layer, the black matrix layer 12 and the CF substrate 11 to a surface of the display device, and then to the outside through the heat convection with air 5.

When a temperature at a surface of the heating source is T₁ and a temperature of air is T₂, the following equation is obtained based on Fourier heat equation:

$${T}_{1} - {T}_{2} = {q}_{x} \cdot ( \frac{L 1}{λ1 A} + \frac{L 2}{λ2 A} + \frac{L 3}{λ3 A} + \frac{L 4}{λ4 A} + \frac{1}{hA} ) , \qquad ( I )$$

where qₓ represents heat flux (in this model, qₓ=I²·R, I represents a current, and R represents a resistance), λ1, λ2, λ3 and λ4 represent thermal conductivity of the display driving layer 22, the liquid crystal layer 3, the color filter layer and the black matrix layer 12, and the CF substrate 11, h represents a convection heat exchange coefficient of air 5, A represents a heat conduction area, and L1, L2, L3, and L4 represent thicknesses of the display driving layer 22, the liquid crystal layer 3, the color filtering layer and the black matrix layer 12, and the CF substrate 11 respectively.

When λ1, λ2, λ3 and λ4 are 8, 8, 0.3 and 0.5 respectively, h is an actual measurement value, e.g., 25.4 W/m²·K, and L1, L2, L3, L4 are 1.05E⁻⁶ m, 3.3E⁻⁶ m, 5E⁻⁶ m, 5E⁻⁴ m respectively. A pixel unit R, G or B is selected, and its size is set as 7.5E⁻⁹ m².

After substituting the numerical values into the above-mentioned equation (I), L1/λ1, L1/λ1, L2/λ2, and are far smaller than 1/h, so the thermal resistance of the convection heat exchange at the display side of the display module is far larger than the thermal resistance of the heat transferred through the display driving layer 22, the liquid crystal layer 3, the color filter layer, the black matrix layer 12 and the CF substrate 11, i.e., there is a large temperature difference between the CF substrate 11 and air, but there is a small temperature difference between the CF substrate 11 and the liquid crystal layer. In other words, the heat generated in the liquid crystal layer 3 is rapidly transferred to a surface of the CF substrate 11, and the heat cannot be accumulated in the liquid crystal cell.

An object of the present disclosure is to provide a display module, a manufacturing method thereof, and a display device, so as to improve a heating rate and a heating temperature of the liquid crystal layer, thereby to reduce a response time of the liquid crystals as well as the power consumption.

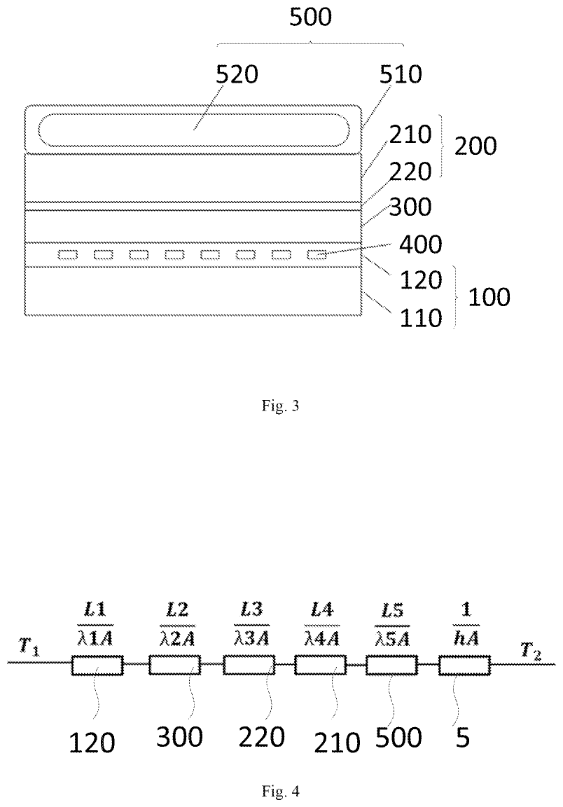

FIG. 3 shows a display module according to one embodiment of the present disclosure.

As shown in FIGS. 3 to 5, the display module includes a liquid crystal cell and a low thermal conductivity medium layer, the liquid crystal cell including: a first substrate 100 and a second substrate 200 arranged opposite to each other, a liquid crystal layer 300 arranged between the first substrate 100 and the second substrate 200, a heating source 400 arranged in the liquid crystal cell and configured to heat the liquid crystal layer 300, and a low thermal conductivity medium layer 500. A side of the first substrate 100 away from the second substrate 200 is a display side, and a side of the second substrate 200 away from the first substrate 100 is a non-display side. At least a part of the low thermal conductivity medium layer 500 is arranged a on a side of the liquid crystal layer 300 close to the display side, and thermal conductivity of the low thermal conductivity medium layer 500 is smaller than a predetermined value. The low thermal conductivity medium layer is configured to at least reduce heat transferred from an interior of the liquid crystal cell to the outside via the display side, so that heat is accumulated in the liquid crystal layer 300.

Based on the above, the heating source 400 is arranged in the liquid crystal cell so as to heat liquid crystals, thereby to increase a response speed of the liquid crystals and improve the display quality. In addition, the low thermal conductivity medium layer 500 with a very small heat conduction coefficient is added as a thermal insulation layer on a side of the liquid crystal layer 300 close to the display side. When the liquid crystals begin to be heated by the heating source 400, due to the very small heat conduction coefficient of the low thermal conductivity medium layer 500, its thermal power is small in the case of a same temperature difference based on the Fourier heat equation, so it is able to reduce a loss rate of the thermal power inside the liquid crystal cell between the display side and air, increase the amount of heat accumulated inside the liquid crystal cell, and increase the temperature inside the liquid crystal cell rapidly, thereby to achieve a rapid response. Moreover, when the heat conduction is maintained in a stable state, because the thermal power and an ambient temperature are both fixed values, the temperature of the liquid crystal layer 300 may increase based on the above-mentioned equation (I). As compared with a display module where the heating source 400 rather than the low thermal conductivity medium layer 500 is provided, it is able to reduce the thermal power in the case of a same temperature of the liquid crystal layer 300, thereby to reduce the power consumption.

Illustratively, the thermal conductivity of the low thermal conductivity medium layer 500 is smaller than the thermal conductivity of all the film layers on the side of the liquid crystal layer 300 close to the non-display side, i.e., the predetermined value is the thermal conductivity of all the film layers on the side of the liquid crystal layer 300 close to the non-display side. In this way, the heat generated by the heating source 400 may be accumulated in the liquid crystal layer 300 as much as possible.

The first substrate 100 is an array substrate, and includes a first base substrate 110 and a display driving layer 120. The second substrate 200 is a color film substrate, and includes a second base substrate 210, a color filter layer, a black matrix layer 220, etc.

In the embodiments of the present disclosure, at least a part of the low thermal conductivity medium layer 500 is arranged inside the liquid crystal cell, or arranged outside the liquid crystal cell. Alternatively, the low thermal conductivity dielectric layer 500 is arranged inside or outside the liquid crystal cell.

Illustratively, when the low thermal conductivity medium layer 500 is arranged outside the liquid crystal cell, at least a part of the low thermal conductivity medium layer 500 is arranged on the display side, e.g., at least part of the low thermal conductivity medium layer 500 is attached to the display side surface of the second substrate 210 of the second substrate 200. When the low thermal conductivity medium layer 500 is arranged inside the liquid crystal cell, at least a part of the low thermal conductivity medium layer 500 is arranged between the base substrate of the first substrate 100 and the liquid crystal layer 300, and at this time, at least a part of the low thermal conductivity medium layer 500 is arranged on one side of the second base substrate close to the liquid crystal layer, e.g., arranged between the second base substrate 210 and the color filtering layer or the black matrix layer 220, or arranged between the color filter layer or the black matrix layer 220 and the liquid crystal layer 300.

It should be appreciated that, when at least a part of the low thermal conductivity medium layer 500 is arranged on aside of the liquid crystal layer 300 close to the display side, it means that the low thermal conductivity medium layer 500 is provided not only on a side of the liquid crystal layer 300 close to the display side, but also in other areas, e.g., on a side of the liquid crystal layer 300 close to the non-display side, or at a periphery of the liquid crystal layer 300, so as to further reduce heat dissipation.

Illustratively, the low thermal conductivity medium layer 500 includes an interlayer formation member 510 for forming an interlayer 520, and the interlayer 520 is filled with a low thermal conductivity medium. In other words, through the interlayer 520, it is able to achieve a thermal insulation effect. For example, the low thermal conductivity medium includes an air medium. Since a heat conduction coefficient of air is very small with respect to the film layers in the liquid crystal cell, air is selected as the low thermal conductivity medium of the interlayer 520 so as to increase the response speed and reduce the power consumption.

Of course, it should be appreciated that, the above is merely for illustrative purposes, and any structure other than air is used to form the low thermal conductivity medium layer 500. For example, a transparent material with low thermal conductivity is used to directly form the low thermal conductivity medium layer 500, or the low thermal conductivity medium in the interlayer 520 is any low thermal conductivity medium other than air.

As shown in FIG. 3, in the embodiments of the present disclosure, the low thermal conductivity medium layer 500 is arranged on the display side of the liquid crystal cell, and the low thermal conductivity medium layer 500 includes the interlayer 520 with air as the low thermal conductivity medium. FIG. 4 shows a heat conduction model (in series), where λ5 represents a heat conduction coefficient of the low thermal conductivity medium layer 500, and L5 represents a thickness of the low thermal conductivity medium layer 500.

The heat conduction coefficient λ5 of air 5 is 0.03 W/m-K, and when the thickness of the low thermal conductivity medium layer 500 is set as d, based on the Fourier heat equation, the temperature of the liquid crystal layer 300 after the heat conduction is in the stable state is greater by ΔT than the temperature of the liquid crystal layer 300 without any low thermal conductivity medium layer 500, and ΔT is expressed as:

$$Δ T = {q}_{x} \cdot \frac{d}{λ 5 A} .$$

When qₓ is 4E⁻⁶ W and A is 7.5 E⁻⁹ m², theoretically

$$Δ T = 4 {E}^{- 6} \cdot \frac{d}{0.03 \cdot 7.5 E - 9} = 1.78 {E}^{4} \cdot d °C . \qquad ( II )$$

Based on the above-mentioned formula (II), as compared with the display module without any low thermal conductivity medium layer 500 in FIG. 1, in the display module with the low thermal conductivity medium layer 500, when the temperature of the liquid crystal layer 300 increases by 10° C., the thickness of the air interlayer 520 of the low thermal conductivity medium layer 500 is merely 0.56 mm.

It should be appreciated that, the particular thickness of the interlayer 520 will not be particularly defined herein. In actual use, the thickness of the interlayer 520 is selected in accordance with an actual product structure.

Illustratively, as shown in FIG. 3, the display module includes a display region and a non-display region surrounding the display region. At least a part of the interlayer formation member 510 includes a transparent enclosure, an internal cavity of the transparent enclosure forms the interlayer 520, and an orthogonal projection of the interlayer 520 onto the first substrate 100 covers at least the display region.

Based on the above, the interlayer formation member 510 is a transparent enclosure for directly receiving a low thermal conductivity medium such as air, so as to form a sandwich-like structure. Through the transparent enclosure, the low thermal conductive medium is provided in the interlayer 520.

In addition, the transparent enclosure is made of a material with excellent optical properties so as to prevent the display quality from being adversely affected. In addition, the material has low thermal conductivity and is easy to be processed. For example, the transparent enclosure is made of an organic material having high light transmittance, such as one or more of polyethylene terephthalate or polyimide.

The transparent enclosure includes an upper layer and a lower layer formed through injection molding or extrusion molding, and the upper layer and the lower layer are sealed through a sealant. The thickness of the interlayer 520 is controlled through adjusting a thickness of the sealant. During the implementation, in order to facilitate the assembling, a size of the transparent enclosure is the same as a size of the substrate in the liquid crystal cell. In addition, in order to satisfy the requirement on the temperature of the display region (AA), the orthogonal projection of the interlayer 520 onto the base substrate of the first substrate 100 covers at least the display region, i.e., an area occupied by the interlayer 520 is the same as, or greater than, an area of the region AA.

It should be appreciated that, in FIG. 3, the low thermal conductivity medium layer 500 is at least partially arranged outside the liquid crystal cell, and the transparent enclosure is adhered to the display side of the second substrate 200. In some other embodiments of the present disclosure, the low thermal conductivity medium layer 500 is at least partially arranged inside the liquid crystal cell, and the transparent enclosure is arranged between the base substrate of the second substrate 200 and the liquid crystal layer 300; or the low thermal conductivity medium layer 500 is arranged between the first substrate 100 and the liquid crystal layer 300 so as to reduce the heat dissipation at the non-display side. Alternatively, the transparent enclosure is disposed at a periphery of the liquid crystal layer 300 so as to reduce the heat dissipation at the periphery of the liquid crystal cell.

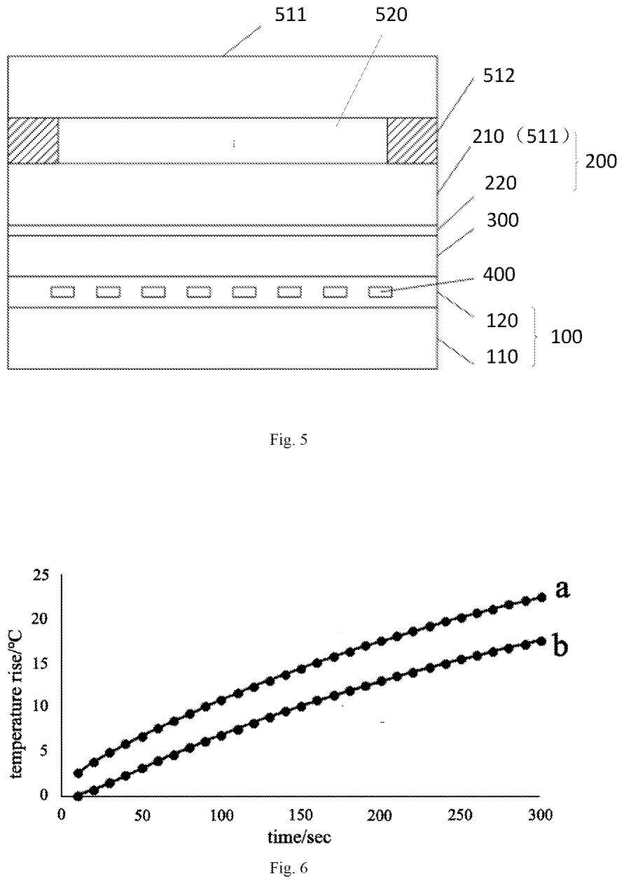

In another possible embodiment of the present disclosure, as shown in FIG. 5, the display module includes a display region and a non-display region surrounding the display region. At least a part of the interlayer formation member 510 includes two transparent clamping plates 511 arranged opposite to each other, and a support layer 512 supported and fixed between the two transparent clamping plates 511 in the non-display region, so as to define the interlayer 520 with the two transparent clamping plates 511.

Based on the above, the interlayer formation member 510 includes the two transparent clamping plates 511 and the support layer 512. For example, in FIG. 5, one of the two transparent clamping plates 511 is a base substrate of the first substrate 100, and the other is a transparent cover plate arranged on the base substrate of the first substrate 100. In other words, the transparent cover plate is arranged on the display side of the liquid crystal cell, and the interlayer 520 is formed between the base substrate of the second substrate 200 and the transparent cover plate through the support layer 512. The interlayer 520 is filled with an air medium. The scheme in FIG. 5 is more suitable for a small-sized display module.

Illustratively, the base substrate and the transparent cover plate are made of at least one of glass, acrylics or polyoxymethylene. The support layer 512 is a sealant.

It should be appreciated that, in FIG. 5, the low thermal conductivity medium layer 500 is at least partially arranged outside the liquid crystal cell, and the transparent cover plate is attached to the display side of the second substrate 200 through the support layer 512. In some other embodiments of the present disclosure, the low thermal conductivity medium layer 500 is at least partially arranged inside the liquid crystal cell, and the transparent clamping plate 511 is arranged between the base substrate of the second substrate 200 and the liquid crystal layer 300; or the transparent clamping plate 511 is arranged between the first substrate 100 and the liquid crystal layer 300 so as to reduce the heat dissipation at the non-display side. Alternatively, the transparent clamping plate 511 is arranged at a periphery of the liquid crystal layer 300 so as to reduce the heat dissipation at the periphery of the liquid crystal cell.

Based on the above, in a low-temperature environment, a temperature at a surface of the liquid crystal display module needs to reach a desired operating temperature in the stable state, and meanwhile a time when the desired operating temperature is reached is also a key index. In the case that no low thermal conductivity medium layer 500 is provided, the heat generated by the heating source 400 is transferred through the film layers on the first substrate 100 and the substrate 200 as well as the base substrate of the second substrate 200 to the outside. At this time, the heat accumulated in the liquid crystal layer 300 is very small with respect to the heat generated by the heating source 400, so the heat loss is very large. However, according to the display module in the embodiments of the present disclosure, the heat conduction coefficient of the low thermal conductivity medium layer 500 is far smaller than that of the other film layer, and the heat generated by the heating source 400 is blocked by the low thermal conductivity medium layer 500, so as to prevent the heat exchange with air. In this way, in the temperature rise, more heat generated by the heating source 400 is accumulated in the liquid crystal layer 300, and the heat loss is reduced, so it is able to improve the energy utilization.

In addition, in some embodiments of the present disclosure, the heating source 400 includes: a heating source terminal arranged in the non-display region, the heating source terminal including a first heating source terminal for outputting a high voltage and a second heating source terminal for outputting a low voltage; and at least one heating electrode arranged between the base substrate of the first substrate 100 and the base substrate of the second substrate 200, both ends of each heating electrode being coupled to the first heating source terminal and the second heating source terminal respectively.

According to the display module in the embodiments of the present disclosure, at least one heating electrode is arranged between the base substrate of the first substrate 100 and the base substrate of the second substrate 200, i.e., the heating electrode is arranged inside the display module. At this time, the heat generated by the heating electrode is directly applied onto liquid crystal molecules in the liquid crystal layer 300, so it is able to start the display module quickly in the low-temperature environment, and ensure the response speed of the liquid crystals. In addition, both ends of each heating electrode are coupled to the first heating source terminal for outputting a high voltage and a second heating source terminal for outputting a low voltage respectively, so it is able to control the heating electrodes separately.

A temperature compensation effect of the display module in the embodiments of the present disclosure will be described hereinafter in more details.

Based on the two heat conduction models in FIGS. 2 and 4 in combination with the above-mentioned theoretical model of the heat conduction mechanism, the interior of the liquid crystal cell is divided into micro-element through finite element analysis, and for any micro-element, a temperature rise at any time point is calculated using an unsteady heat conduction theory, i.e., C·m·ΔT=W (_{work into the micro-element})-W (_{work from the micro-element}) (III), where C represents a specific heat capacity of a material, m represents the mass of the micro-element, ΔT represents the temperature rise of the micro-element, and W (_{work into the micro-element})-W (_{work into the micro-element}) is just the amount of energy accumulated in the micro-element.

Through calculating ΔT of the micro-element at each time point in an unsteady process, it is able to obtain the temperature rise of the liquid crystal cell at each position and at each time point.

Based on the above-mentioned formula (III) in conjunction with the above-mentioned analysis on the low thermal conductivity medium layer 500, it is able to obtain a temperature change on the display side of the liquid crystal cell along with time, as shown in FIG. 6, where a curve a indicates the temperature change on the display side of the display module in the embodiments of the present disclosure along with time, and a curve b indicates the temperature change on the display side of the conventional display module without any low thermal conductivity medium layer 500 along with time.

The data simulation shows that, in the case of same input power, the temperature on the display side of the liquid crystal cell of the display module with the low thermal conductivity medium layer is obviously higher, by about 5° C., than the temperature on the display side of the liquid crystal cell without the low thermal conductivity medium layer. In other words, for a same temperature on the display side, the thermal power for the display module in the embodiment of the present disclosure is lower, so it is able to reduce the power consumption.

The present disclosure further provides in some embodiments a display device which includes the above-mentioned display module.

The present disclosure further provides in some embodiments a method for manufacturing the above-mentioned display module, which includes forming a first substrate 100 and a second substrate 200 in such a manner as to be arranged opposite to each other, and forming a liquid crystal layer 300 between the first substrate 100 and the second substrate 200 to form a liquid crystal cell. The liquid crystal cell is provided with a heating source 400 for heating the liquid crystal layer 300, the heating source 400 is arranged on at least one of the first substrate 100 and the second substrate 200, a low thermal conductivity medium layer 500 is formed at least on a display side of the first substrate 100 or a side of the first substrate 100 close to the liquid crystal layer 300, thermal conductivity of the low thermal conductivity medium layer 500 is smaller than a predetermined value, and the low thermal conductivity medium layer 500 is configured to at least reduce heat transferred from an interior of the liquid crystal cell to the outside via the display side, so as to accumulate the heat in the liquid crystal layer 300.

Illustratively, when the display module has the structure as shown in FIG. 3, the forming the low thermal conductivity medium layer 500 at least on the display side of the first substrate 100 or a side of the first substrate 100 close to the liquid crystal layer 300 specifically includes: forming two layers of thin films through extrusion molding or injection molding, and applying a sealant so as to form a transparent enclosure with an interlayer 520, a thickness of the interlayer 520 being determined in accordance with a thickness of the sealant; and attaching the transparent enclosure to a side of the first substrate 100 close to the display side or a side of the first substrate 100 close to the liquid crystal layer 300.

Illustratively, when the display module has the structure as shown in FIG. 5, the forming the low thermal conductivity medium layer 500 on at least the display side of the first substrate 100 or a side of the first substrate 100 close to the liquid crystal layer 300 specifically includes enabling a transparent cover plate to be arranged opposite to a base substrate of the first substrate 100 through a support layer 512 at a periphery of the transparent cover plate, and the transparent substrate is arranged on the display side of the first substrate 100 or on a side of the first substrate 100 close to the liquid crystal layer 300.

Some description will be given as follows.

(1) The drawings merely relate to structures involved in the embodiments of the present disclosure, and the other structures may refer to those known in the art.

(2) For clarification, in the drawings for describing the embodiments of the present disclosure, a thickness of a layer or region is zoomed out or in, i.e., these drawings are not provided in accordance with an actual scale. It should be appreciated that, in the case that such an element as layer, film, region or substrate is arranged “on” or “under” another element, it may be directly arranged “on” or “under” the other element, or an intermediate element may be arranged therebetween.

(3) In the case of no conflict, the embodiments of the present disclosure and the features therein may be combined to acquire new embodiments.

The above embodiments are merely for illustrative purposes, but shall not be construed as limiting the scope of the present disclosure. The scope of the present disclosure shall be subject to the scope defined by the appended claims.

1. A display module, comprising:
a liquid crystal cell comprising a first substrate and a second substrate arranged opposite to each other, a liquid crystal layer arranged between the first substrate and the second substrate, and a heating source arranged in the liquid crystal cell and configured to heat the liquid crystal layer, a side of the first substrate away from the second substrate being a display side, and a side of the second substrate away from the first substrate being a non-display side; and
a low thermal conductivity medium layer, at least a part of the low thermal conductivity medium layer being arranged on a side of the liquid crystal layer close to the display side, thermal conductivity of the low thermal conductivity medium layer being smaller than a predetermined value, the low thermal conductivity medium layer being configured to at least reduce heat transferred from an interior of the liquid crystal cell to the outside via the display side, so as to accumulate the heat in the liquid crystal layer.

2. The display module according to claim 1, wherein the predetermined value is thermal conductivity of all film layers on a side of the liquid crystal layer close to the non-display side.

3. The display module according to claim 1, wherein at least a part of the low thermal conductivity medium layer is arranged inside the liquid crystal cell, and/or at least a part of the low thermal conductivity medium layer is arranged outside the liquid crystal cell.

4. The display module according to claim 1, wherein when the low thermal conductivity medium layer is arranged outside the liquid crystal cell, at least a part of the low thermal conductivity medium layer is arranged on the display side; and when the low thermal conductivity medium layer is arranged inside the liquid crystal cell, at least a part of the low thermal conductivity medium layer is arranged between a base substrate of the first substrate and the liquid crystal layer.

5. The display module according to claim 1, wherein the low thermal conductivity medium layer comprises an interlayer formation member for forming an interlayer, and the interlayer is filled with a low thermal conductivity medium.

6. The display module according to claim 5, wherein the low thermal conductivity medium comprises an air medium.

7. The display module according to claim 5, wherein the display module comprises a display region and a non-display region surrounding the display region, at least a part of the interlayer formation member comprises a transparent enclosure, an internal cavity of the transparent enclosure forms the interlayer, and an orthogonal projection of the interlayer onto the first substrate at least covers the display region.

8. The display module according to claim 7, wherein the transparent enclosure is made of one or more of polyethylene terephthalate and polyimide.

9. The display module according to claim 5, wherein the display module comprises a display region and a non-display region arranged at a periphery of the display region, wherein at least a part of the interlayer formation member comprises: two transparent clamping plates arranged opposite to each other to form a cell; and a support layer fixed between the two transparent clamping plates in the non-display region to form the interlayer with the two transparent clamping plates.

10. The display module according to claim 9, wherein one of the two transparent clamping plates is the base substrate of the first substrate, and the other is a transparent cover plate arranged on the base substrate of the first substrate.

11. The display module according to claim 10, wherein the base substrate and the transparent cover plate are made of at least one of glass, acrylics or polyoxymethylene.

12. The display module according to claim 1, wherein the display module comprises a display region and a non-display region arranged at a periphery of the display region, wherein the heating source comprises: a heating source terminal arranged in the non-display region, the heating source terminal comprising a first heating source terminal for outputting a high voltage and a second heating source terminal for outputting a low voltage; and at least one heating electrode arranged between a base substrate of the first substrate and a base substrate of the second substrate, both ends of each heating electrode being coupled to the first heating source terminal and the second heating source terminal respectively.

13. A display device, comprising the display module according to claim 1.

14. A method for manufacturing the display module according to claim 1, comprising forming a first substrate and a second substrate in such a manner as to be arranged opposite to each other, and forming a liquid crystal layer between the first substrate and the second substrate to form a liquid crystal cell, wherein the liquid crystal cell is provided with a heating source for heating the liquid crystal layer, the heating source is arranged on at least one of the first substrate and the second substrate, a low thermal conductivity medium layer is formed at least on a display side of the first substrate or a side of the first substrate close to the liquid crystal layer, thermal conductivity of the low thermal conductivity medium layer is smaller than a predetermined value, and the low thermal conductivity medium layer is configured to at least reduce heat transferred from an interior of the liquid crystal cell to the outside via the display side, so as to accumulate the heat in the liquid crystal layer.

15. The method according to claim 14, wherein when the display module comprises a display region and a non-display region surrounding the display region, at least a part of the interlayer formation member comprises a transparent enclosure, an internal cavity of the transparent enclosure forms the interlayer and an orthogonal projection of the interlayer onto the first substrate at least covers the display region, the forming the low thermal conductivity medium layer at least on the display side of the first substrate or a side of the first substrate close to the liquid crystal layer specifically comprises: forming two layers of thin films through extrusion molding or injection molding, and applying a sealant so as to form a transparent enclosure with an interlayer, a thickness of the interlayer being determined in accordance with a thickness of the sealant; and attaching the transparent enclosure to a side of the first substrate close to the display side or a side of the first substrate close to the liquid crystal layer, or
when one of the two transparent clamping plates is the base substrate of the first substrate and the other is a transparent cover plate arranged on the base substrate of the first substrate, the forming the low thermal conductivity medium layer on at least the display side of the first substrate or a side of the first substrate close to the liquid crystal layer specifically comprises enabling a transparent cover plate to be arranged opposite to a base substrate of the first substrate through a support layer at a periphery of the transparent cover plate, and the transparent substrate is arranged on the display side of the first substrate or on a side of the first substrate close to the liquid crystal layer.

16. The display device according to claim 13, wherein the predetermined value is thermal conductivity of all film layers on a side of the liquid crystal layer close to the non-display side.

17. The display device according to claim 13, wherein at least a part of the low thermal conductivity medium layer is arranged inside the liquid crystal cell, and/or at least a part of the low thermal conductivity medium layer is arranged outside the liquid crystal cell.

18. The display device according to claim 13, wherein when the low thermal conductivity medium layer is arranged outside the liquid crystal cell, at least a part of the low thermal conductivity medium layer is arranged on the display side; and when the low thermal conductivity medium layer is arranged inside the liquid crystal cell, at least a part of the low thermal conductivity medium layer is arranged between a base substrate of the first substrate and the liquid crystal layer.

19. The display device according to claim 13, wherein the low thermal conductivity medium layer comprises an interlayer formation member for forming an interlayer, and the interlayer is filled with a low thermal conductivity medium.

20. The display device according to claim 19, wherein the low thermal conductivity medium comprises an air medium.
